(19) United States
(12) Patent Application Publication
(10) Pub. No.: US 2013/0083955 A1
(43) Pub. Date: Apr. 4, 2013

(54) HEADPHONE

(71) Applicant: Takayuki MIYAZAWA, Kawasaki-shi (JP)

(72) Inventor: Takayuki MIYAZAWA, Kawasaki-shi (JP)

(73) Assignee: JVC KENWOOD CORPORATION, Yokohama-shi (JP)

(21) Appl. No.: 13/614,439

(22) Filed: Sep. 13, 2012

(30) Foreign Application Priority Data
Sep. 30, 2011 (JP) 2011-217180
Sep. 30, 2011 (JP) 2011-217184
Sep. 30, 2011 (JP) 2011-217204

(51) Int. Cl. H04R 1/10

(52) U.S. Cl. 381/378

(57) ABSTRACT

A headphone includes: a housing, a hanger, and a bracket accommodated in the housing. The hanger includes: a connecting portion formed in a ring-shape; and a pair of engagement portions opposite to each other in a radial direction of the connecting portion and supports the housing unit to allow the housing unit to rotate. The bracket includes: a flexible curved base; and a pair of protrusions protruding at both ends of the base portion in directions away from each other on an axis penetrating the both ends. The housing includes a pair of through holes at positions corresponding to the pair of engagement portions. The pair of protrusions is rotatably engaged with the pair of engagement portions through the pair of through holes.

### CROSS REFERRENCE TO RELATED APPLICATION

This application is based upon and claims the benefit of priority under 35 U.S.0 §119 to Japanese Patent Applications No. P2011-217180, filed on Sep. 30, 2011, No. P2011-217184, filed on Sep. 30, 2011, and No. P2011-217204, filed on Sep. 30, 2011, the entire contents of which are incorporated herein by reference.

### BACKGROUND

The embodiment relates to a headphone and specifically relates to a headphone including a hanger which connects a headband to each housing, a portion of the hanger connected to the housing has a ring shape.

One of known headphones includes: a head band; housings accommodating speakers; and hangers connecting the head band and the respective housings, a portion of each hanger connected to the corresponding housing unit (hereinafter referred to as a connecting portion) has a U shape. An example of such type of headphones is described in Japanese Patent Laid-open Publication No. 5-199579 (Patent Literature 1).

In the headphone described in Patent Literature 1, the connecting portion of the hanger is made of resin and has a U shape. At the respective ends of the U shape, a pair of support pins is individually protruded toward each other. In each housing unit, insertion holes which receive the pair of support pins are formed.

In the assembly of the headphone, the hanger is attached to the housing unit by the following operations. The ends of the U-shaped connecting portion are elastically forced apart, and the housing unit is placed between the ends. In the process of restoring the hanger to the original shape, the pair of support pins is inserted into the respective insertion holes.

### SUMMARY

In recent years, headphones are rapidly spreading, and the attention is focused on not only the acoustic characteristics of the headphones but also exterior designs thereof. The hangers are important parts for the appearance of the headphones and serve as design accents. Accordingly, the hangers in which the connecting portions connected to the respective housings have closed ring shape, instead of U shape with open ends, are proposed and commercialized.

Such a hanger having a ring-shaped connecting portion is expected to be attached to the housing in the following manner. In the connecting portion, a pair of support pins protruding toward each other in a radial direction is formed. The housing is provided with insertion holes corresponding to the pair of support pins. The pair of support pins is engaged with the insertion holes to attach the hanger to the housing.

In such a case, for the hunger has a closed ring shape, it is difficult to attach the hanger to the housing by elastically deforming and widening the hanger in a similar manner to the U-shaped hanger.

As shown in FIG. 1, by using elastic deformation of a U-shaped hanger 102, which is made of resin from the base of each arm of the U-shape to the end thereof (a range indicated by D100), earpieces of the headphone can swivel.

The swivel refers to rotation (indicated by an arrow DR100) of an earpiece around an axis CL 100, which extends substantially in the vertical direction when the headphone is worn over the head. It is preferable that swivel be performed against proper resistive force because such headphones with swivel earpieces can provide a better fit.

In the headphone including the conventional U-shaped hanger 102, which is made of resin, the swivel can be performed against proper resistive force without requiring additional components.

However, the hanger including a ring-shaped connecting portion can elastically deformed very little because the connecting portion has a closed shape. Accordingly, the swivel cannot be substantially performed only by elastic deformation of the hanger. This problem is desired to be improved.

An object to be solved by the embodiment is to provide a headphone which can implement the swivel to provide a good fit even if the headphone includes a hanger provided with a ring-shaped connecting portion.

In order to solve the aforementioned conventional technical problem, an aspect of the embodiment provides a headphone comprising: a housing; a hanger which includes: a connecting portion formed in a ring-shape; and a pair of engagement portions opposite to each other in a radial direction of the connecting portion and supports the housing unit to allow the housing unit to rotate; and a bracket which is accommodated in the housing and includes: a flexible curved base; and a pair of protrusions protruding at both ends of the base portion in directions away from each other on an axis penetrating the both ends, in which the housing includes a pair of through holes at positions corresponding to the pair of engagement portions, and the pair of protrusions are rotatably engaged with the pair of engagement portions through the pair of through holes.

### BRIEF DESCRIPTION OF THE DRAWINGS

FIG. 1 is a perspective view for explaining a conventional headphone.

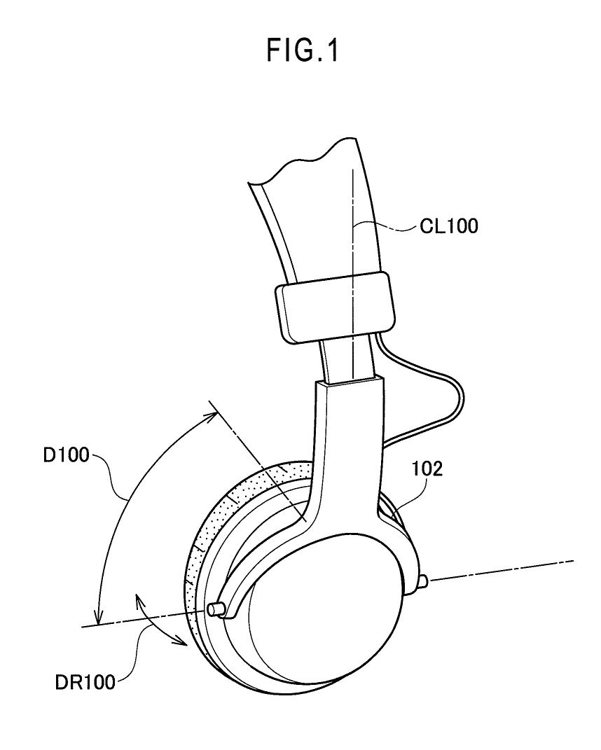

FIG. 2 is an exterior perspective view for explaining an embodiment of a headphone.

FIG. 3 is a side view of a main unit of the embodiment of the headphone.

FIG. 4 is a perspective view of the main unit of the embodiment of the headphone.

FIG. 5 is a four-side view of a baffle of the embodiment of the headphone.

FIG. 6 is a four-side view of a case of the embodiment of the headphone.

FIG. 7 is a perspective view of the case of the embodiment of the headphone.

FIG. 8 is a four-side view of a hanger of the embodiment of the headphone.

FIG. 9 is a perspective view of the hanger of the embodiment of the headphone.

FIG. 10 is an enlarged view of a main portion of the hanger of the embodiment of the headphone.

FIG. 11 is a three-side view of an arch bracket of the embodiment of the headphone.

FIG. 12 is a perspective view of the arch bracket of the embodiment of the headphone.

FIG. 13 is an enlarged view of a main portion of the arch bracket of the headphone of the embodiment.

FIG. 14 is a plan view illustrating the embodiment of the headphone in the assembly process.

FIG. 15 is an exploded view of the embodiment of the headphone.

FIG. 16 is a cross-sectional view of the main unit of the embodiment of the headphone.

### DETAILED DESCRIPTION

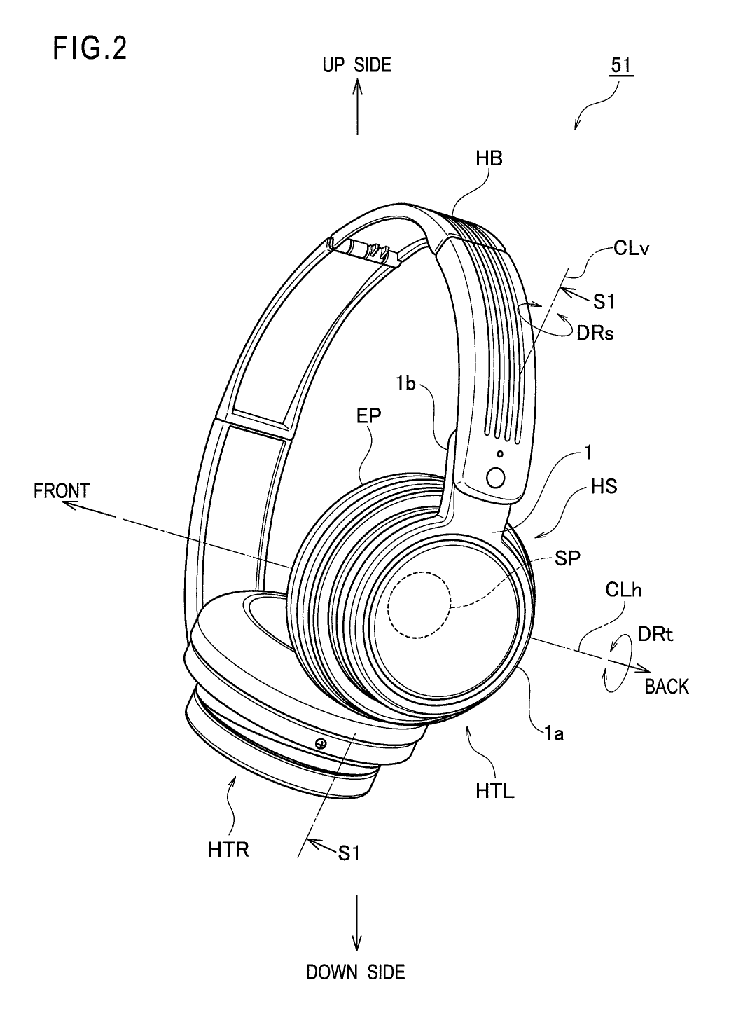

With reference to FIGS. 2 to 16, a description is given of an aspect of the embodiment using a preferred example. FIG. 2 is an exterior perspective view showing a headphone 51 as an embodiment of a headphone.

The headphone 51 is a so-called overhead type including a main unit HTL for a left ear and a main unit HTR for a right ear, which are connected by a headband HB.

The main units HTL and HTR have symmetrical shapes, and the following description is given of the main unit HTL except as otherwise noted. Moreover, up, down, front, back, inward, and outward directions are defined and shown in the drawings when needed.

As shown in FIG. 2, the main unit HTL includes: a housing HS accommodating a speaker SP inside; a hanger 1 including a ring-shaped connecting portion la, which supports the housing HS so as to rotate the same in a predetermined angular range around an axis CLh; and an ear pad EP detachably attached to the housing HS. The headband HB is connected to an arm portion lb of the hanger 1.

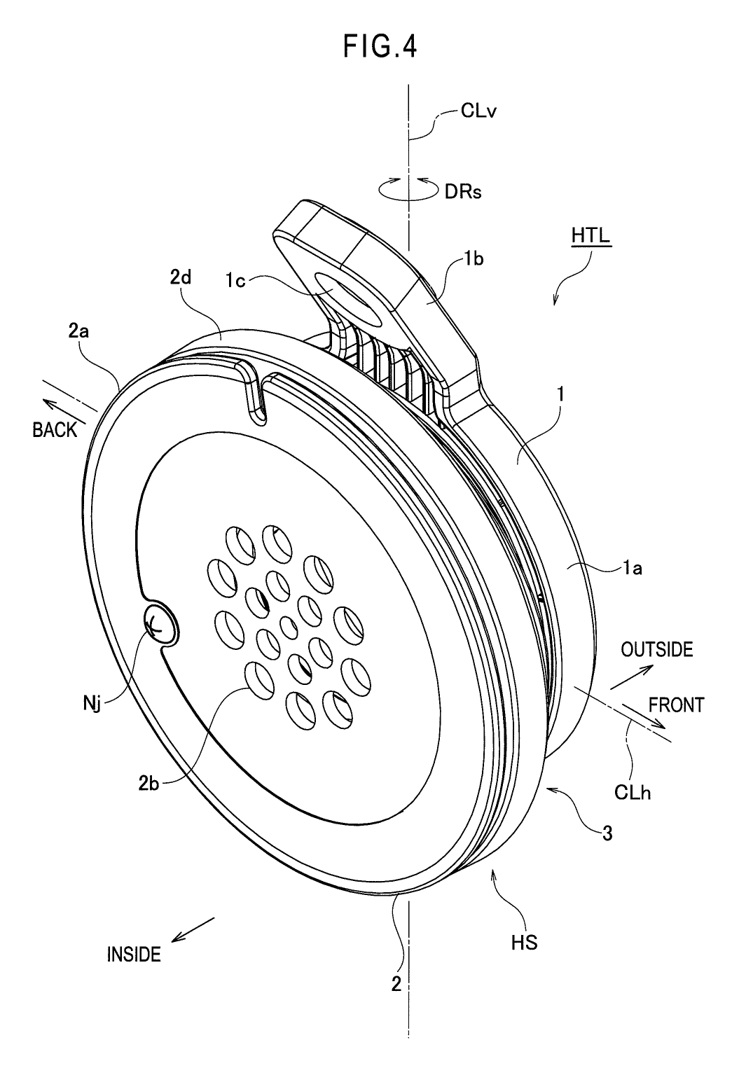

In the main unit HTL, the housing HS is rotatable relative to the hanger 1 in a predetermined angular range around an axis CLv (in the direction of an arrow DRs, see FIG. 4), which extends in the vertical direction orthogonal to the axis CLh, which extends in the front-back direction. That is to say, the main unit HTL is capable of swiveling.

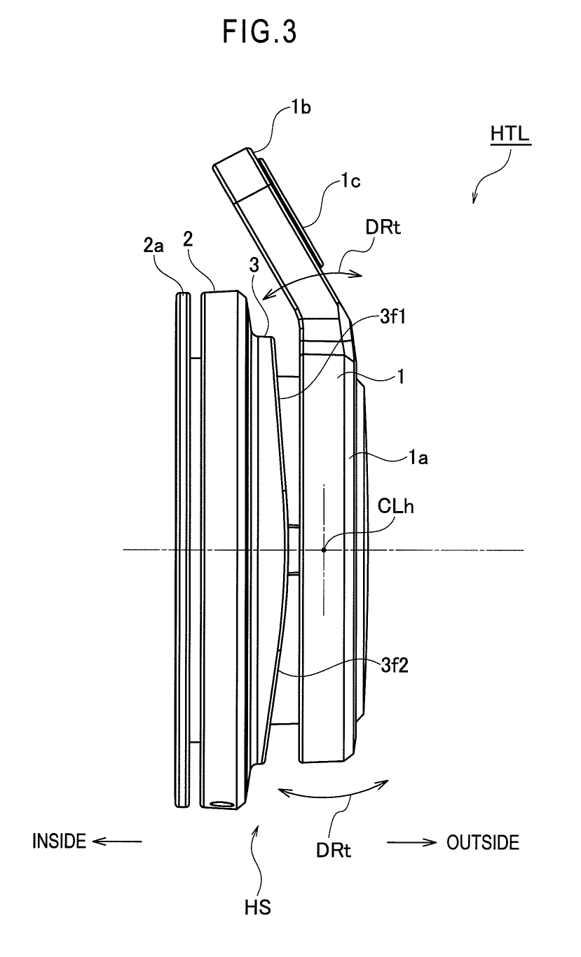

Moreover, in the main unit HTL, the housing HS is rotatable relative to the hanger 1 in a predetermined angular range around the axis CLh (in the direction of an arrow DRt, see FIG. 3), which extends in the front-back direction. That is to say, the main unit HTL is capable of tilting.

With reference to mainly FIGS. 3 and 4, the schematic configuration of the housing HS is described.

FIG. 3 is a plan view of the main unit HTL from the front side of FIG. 2. FIG. 4 is a perspective view of the main unit HTL from the upper front as seen from the backside of the page of FIG. 2. FIGS. 3 and 4 both show the main unit HTL with the ear pad EP removed.

The housing HS includes: a baffle 2, which is located on the head side when the headphone 51 is worn over the head; and a case 3, which is located on the outer side. The baffle 2 inside and the case 3 outside are combined.

The baffle 2 includes a flange 2a on the inner side. The ear pad EP is attached to the flange 2a. Moreover, the baffle 2 includes plural sound emission holes 2b in central part. Sound from the speaker SP, which is accommodated within the housing HS, is emitted through the sound emission holes 2b to the outside.

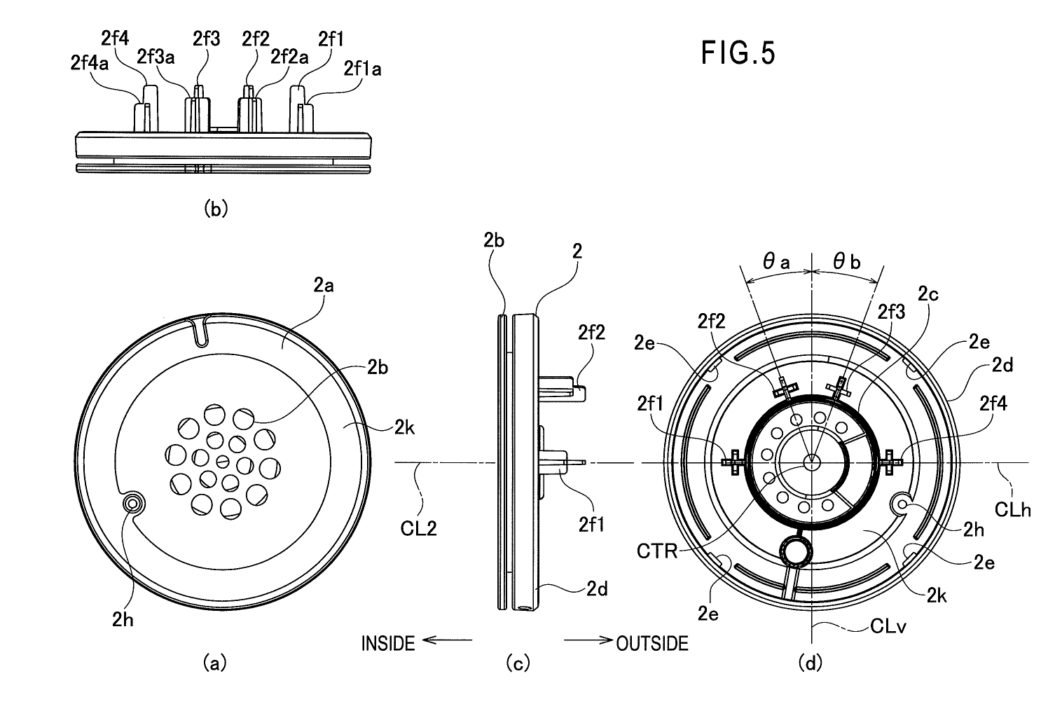

With reference to FIGS. 5 to 8, the members are described in detail.

First, the baffle 2 is described in detail with reference to mainly FIG. 5.

FIG. 5 is a four-side view of the baffle 2. In FIG. 5, (a) is a front view of the baffle 2; (b), a top view thereof; (c), a right side view thereof; and (d), a back view thereof.

The baffle 2 is made of resin and includes a base 2k, which is formed in a substantially circular plate-shape. On the inside of the base 2k, the flange 2a is formed as described above. In the center of the base 2k, the plural sound emission holes 2b are formed.

At the center of the outer surface of the base 2k, a circular rib 2c is formed. The speaker SP is attached to the part surrounded by the rib 2c. At the edge of the outer surface of the base 2k, a peripheral wall 2d, which protrudes outward, is formed. On the inner surface of the peripheral wall 2d, four engagement protrusions 2e protruding toward the center are formed so as to be separated from each other.

On the outer surface of the base 2k, four ribs 2f1 to 2f4 are stood. The four ribs 2f1 to 2f4 are located at substantially equal distances from the center CTR of the base 2k in the radial direction. As for the circumferential direction, the ribs 2f1 and 2f4 are provided on the horizontal axis CLh, and the ribs 2f2 and 2f3 are respectively provided at an angle θa clockwise and at an angle θb counterclockwise from the vertical axis CLv, which is orthogonal to the axis CLh.

In the example of FIG. 5, θa=θb.

In the base 2k, a through hole 2h is formed. Through the through-hole 2h, a male screw Nj (see FIG. 4) is inserted to fasten the baffle 2 and the case 3 which are engaged with each other by a bayonet structure later described. The male screw Nj is a tapping screw, for example. Hereinafter, the male screw Nj is referred to as a tapping screw Nj.

As shown in (b) of FIG. 5, the ribs 2f1 to 2f4 are provided with step portions 2f1a to 2f4a at the tops thereof, respectively. An arch bracket 5 is inserted into a rectangular regions corresponding to the step portions 2f1a to 2f4a. The details thereof are described later.

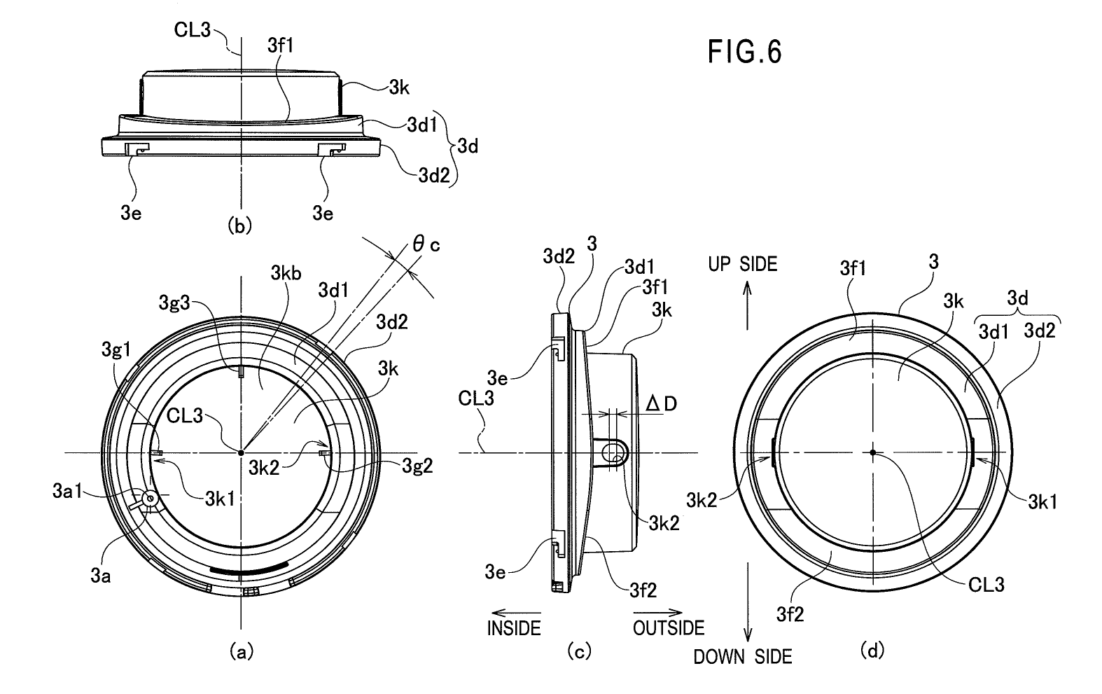

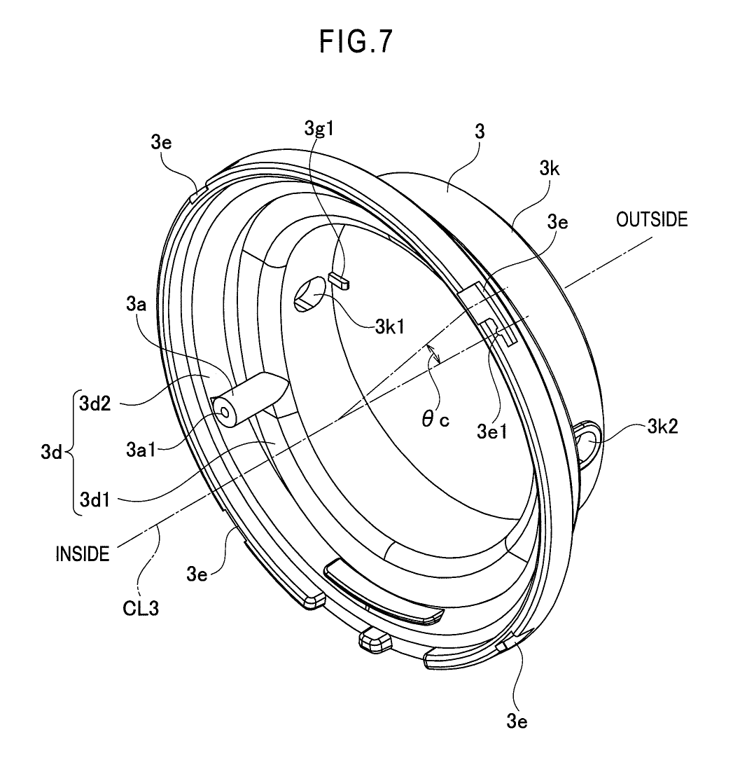

Next, the case 3 is described in detail with reference to mainly FIGS. 6 and 7.

FIG. 6 is a four-side view of the case 3. In FIG. 6, (a) is a front view of the case 3; (b), a top view thereof; (c), a right side view thereof; and (d), a back view thereof. FIG. 7 is a perspective view of the case 3.

The case 3 includes a base 3k having a pan shape with a closed bottom and a step portion 3d which increases stepwise in diameter starting from the edge of the base 3k. The case 3 is made of resin.

The step portion 3d includes a first step portion 3d1 and a second step portion 3d2, which are arranged in this order from the base 3k side.

In (a) of FIG. 6, a boss 3a is provided on the inner surface of the first step portion 3d1. The boss 3a protrudes in the axis CL3 direction and is provided with a tap drill hole 3a1.

In the base 3k, a pair of through-holes 3k1 and 3k2 are formed at the positions opposite to each other in a radial direction. The through-holes 3k1 and 3k2 are elongated holes longitudinal in the axis CL3 direction.

On the outer circumferential surface of the second step portion 3d2, four engagement recesses 3e are formed so as to be spaced from each other in the circumferential direction. Each of the engagement recesses 3e has a substantially L shape which extends from the edge of the second step portion 3d2 in the axis CL3 direction and bends in the circumferential direction. The engagement recesses 3e can be engaged with the engagement protrusions 2e of the baffle 2. The engagement recesses 3e and protrusions 2e are engaged with each other to integrate the baffle 2 and case 3.

The concrete engagement operation is as follows. The baffle 2 and case 3 are positioned so that the engagement recesses 2e and protrusions 3e correspond to each other and are then pressed in directions toward each other. The engagement protrusions 2e are engaged with portions of the engagement recesses 3e extending along the axis CL3.

Thereafter, the baffle 2 is rotated clockwise by an angle θc. The protrusions (not shown) provided on the surfaces of the engagement protrusions 2e of the baffle 2 on the inner side then fit into respective grooves 3e1 of the engagement recesses 3e, which provides a click feeling and holds the baffle 2 and case 3 stably at that position. This is a so-called bayonet structure.

Furthermore, the tapping screw Nj is inserted into the through-holes 2h and is screwed into the drill hole 3a1, thus integrating the baffle 2 and case 3 more stably.

The surface of the first step portion 3d1 on the outer side includes inclined surfaces 3f1 and 3f2. Upper part of the inclined surface 3f1 is inclined inward, and lower part of the inclined surface 3f2 is inclined inward.

On a bottom surface 3kb of the inside of the base 3k, ribs 3g1 and 3g2 are formed at the radial positions corresponding to the through-holes 3k1 and 3k2, respectively. At the top of the inside of the base 3k, a rib 3g3 is formed.

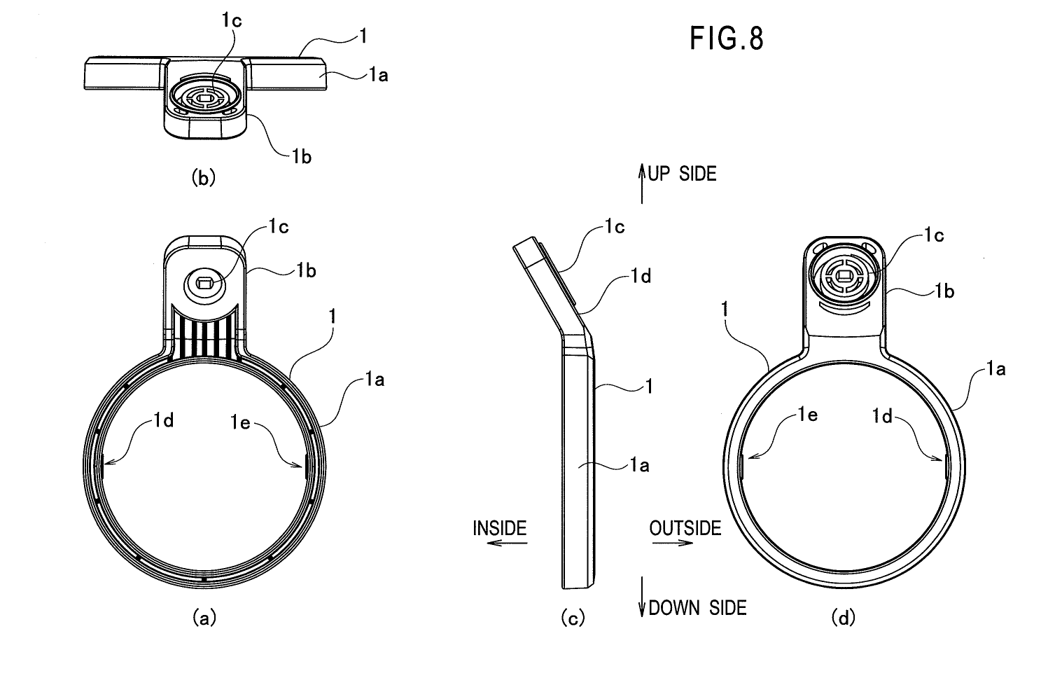

Next, the hanger 1 is described in detail with reference to FIGS. 8 to 10.

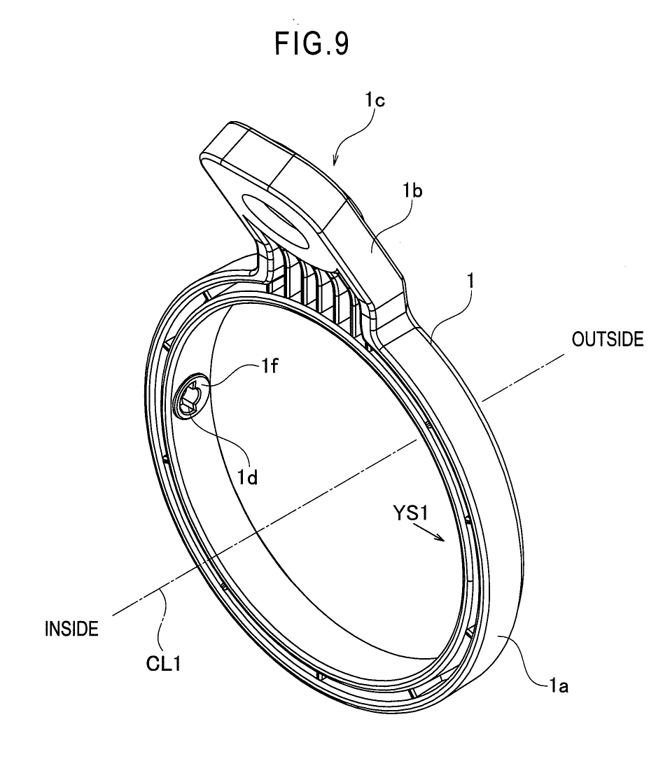

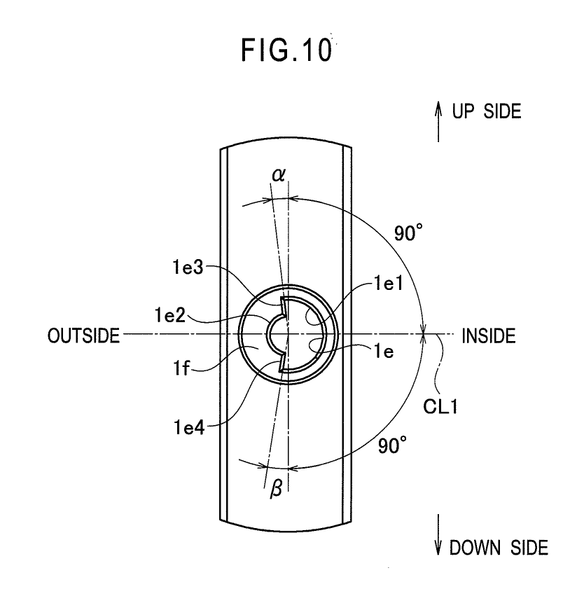

FIG. 8 is a four-side view of the hanger 1. In FIG. 8, (a) is a front view of the hanger 1; (b), a top view thereof; (c), a right side view thereof; and (d), a back view thereof. FIG. 9 is a perspective view of the hanger 1. FIG. 10 is a partial plan view of a main portion (the engagement hole le) of the hanger 1 which is seen in the direction of an arrow YS1 of FIG. 9.

The hanger 1 includes the connecting portion 1a having a circular ring-shape and the arm portion 1b protruding from the connecting portion 1a outward in the radial direction at an inward slight inclined angle. The hanger 1 is made of resin. The arm portion 1b includes a headband engagement portion 1c, which is engaged and connected with the headband HB.

In (a) of FIG. 8, the pair of engagement holes 1d and 1e, whose bottoms are closed, are formed in a radial direction orthogonal to the direction that the arm portion 1b of the connecting portion 1a extends.

In FIG. 10, the engagement hole 1e is provided for a seating 1f, which is a little protruded so as to form a circular flat surface.

The engagement hole 1e includes a large-diameter circumferential surface 1e1, a small-diameter circumferential surface 1e2, and abutment surfaces 1e3 and 1e4 connecting the both circumferential surfaces 1e1 and 1e2 in the radial direction.

Specifically, the circumferential surface 1e1 is formed in an angular range between (90+α) degrees above an axis CL1 and (90+β) below the same. In the example shown in FIG. 10, α degrees=β degrees. The engagement hole 1d has a same shape as the engagement hole 1e and has a large diameter circumferential surface on the inner side.

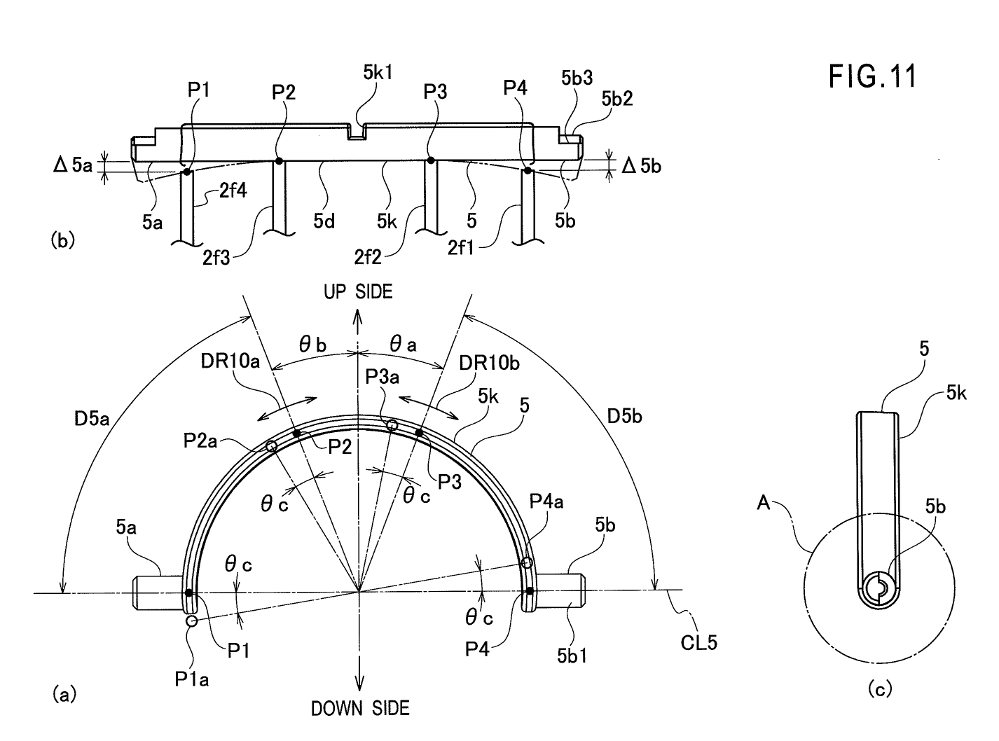

Next, the arch bracket 5 is described with reference to FIGS. 11 to 13. In the headphone 51, the arch bracket 5 connects the hanger 1 and case 3.

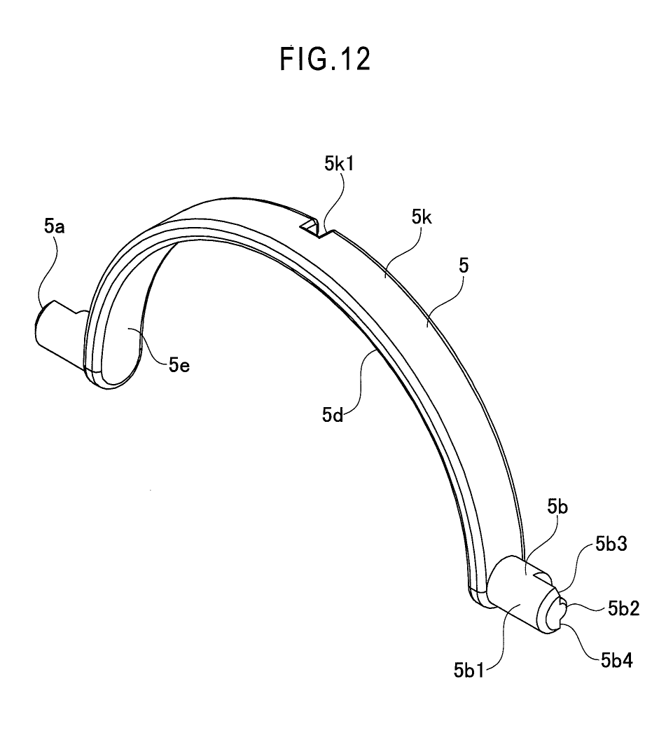

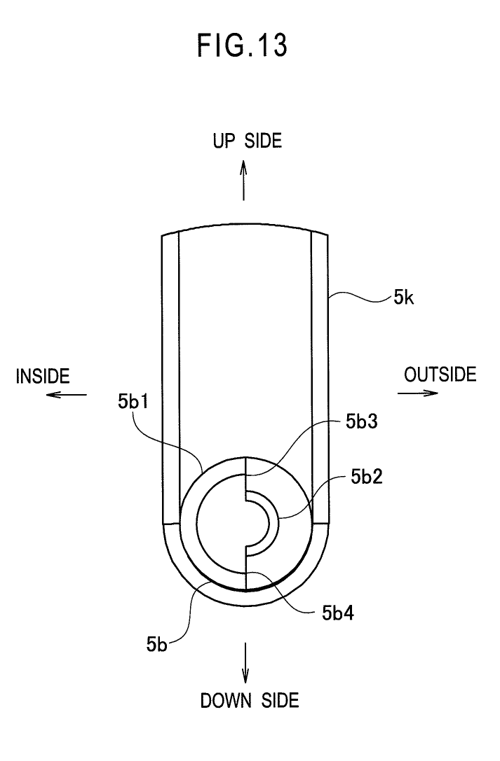

FIG. 11 is a three-side view of the arch bracket 5. In FIG. 11, (a) is a front view of the arch bracket 5; (b), a top view thereof; and (c), a right side view thereof. FIG. 12 is a perspective view of the arch bracket 5. FIG. 13 is an enlargement view of part A of (c) of FIG. 11.

The arch bracket 5 includes a substantially semi-circular base 5k and a pair of protrusions 5a and 5b protruding outward in the radial direction from the both ends of the base 5k. The arch bracket 5 is made of resin having elasticity.

The base 5k has such a curved profile that can be accommodated along the inner circumferential surface of the base 3k in the base 3k of the case 3.

The base 5k includes a notch 5k1 at the center in a side surface. The notch 5k1 is provided to be engaged with the rib 3g3 of the case 3 and prevent the case 3 from being attached to the arch bracket 5 in a wrong way (inside out).

In the arch bracket 5, in other words, the pair of protrusions 5a and 5b protrude in directions away from each other on an axis passing through the both ends of the curved base 5k.

The protrusion 5b, which is shown in detail in FIG. 13, includes a large-diameter circumferential surface 5b1, a small-diameter circumferential surface 5b2, and abutment surfaces 5b3 and 5b4 connecting the both circumferential surfaces 5b1 and 5b2 in the radial direction. The circumferential surfaces 5b1 and 5b2 are formed in ranges of 180 degrees separated on the inner and outer sides, respectively. The abutment surfaces 5b3 and 5b4 are on a same plane vertically extending.

The protrusion 5a has a symmetrical shape to the protrusion 5b. In the protrusion 5a, a large-diameter circumferential surface is formed on the side opposite to the notch 5k1 in a similar manner to the protrusion 5b.

The protrusions 5a and 5b are rotatable in respective predetermined angular ranges when being engaged with the engagement holes 1d and 1e of the hanger 1, respectively.

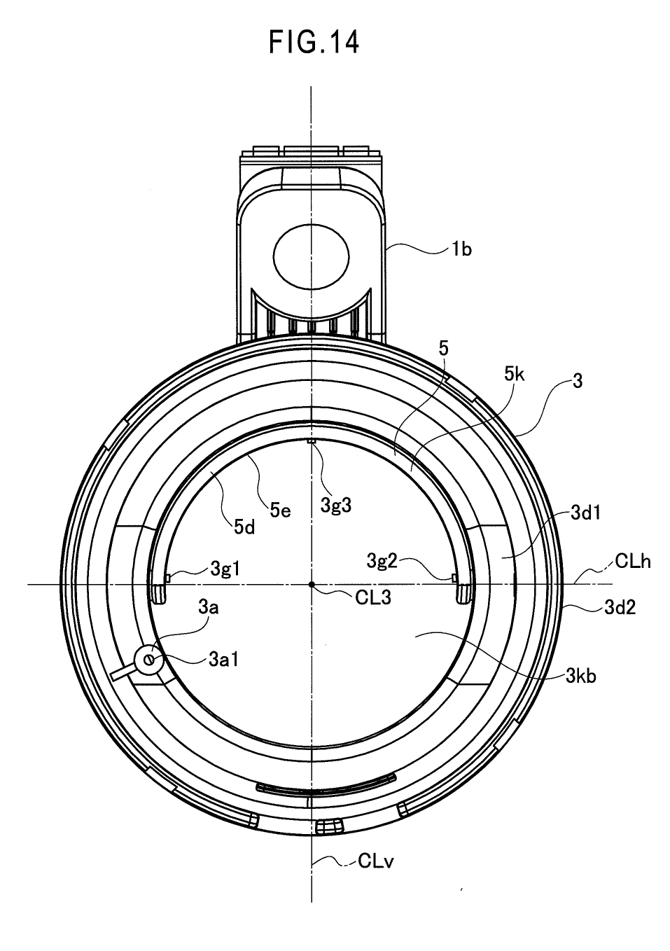

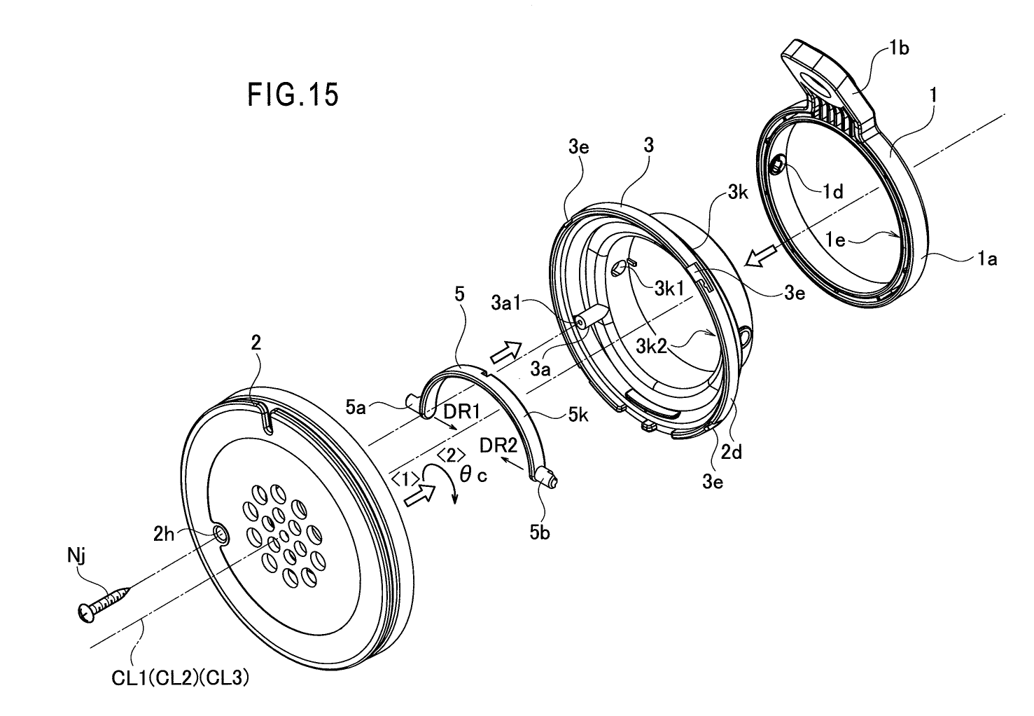

Next, a description is given of a process of assembling the main unit HTL in detail with reference to mainly FIGS. 14 and 15. FIG. 14 is a plan view showing the hanger 1 and case 3 integrated using the arch bracket 5. FIG. 15 is an exploded view of the main unit HTL.

The speaker SP is previously attached to the baffle 2. First, the base 3k of the case 3 is inserted into the ring-shaped connecting portion 1a of the hanger 1. The hanger 1 and case 3 are then positioned so that the engagement holes 1d and 1e correspond to the through-holes 3k1 and 3k2 of the case 3, respectively.

Next, the arch bracket 5 is deformed so that the both ends thereof come close to each other (in the directions of arrows DR1 and DR2) and is inserted into the base 3k of the case 3. Thereafter, the deformed bracket 5 is released to insert the protrusions 5a and 5b into the through-holes 3k1 and 3k2 of the case 3, respectively. The protrusions 5a and 5b are then engaged with the engagement holes 1d and 1e of the hanger 1, respectively.

The protrusions 5a and 5b have enough protruding lengths to pass through the through-holes 3k1 and 3k2 and fit into the engagement holes 1d and 1e, respectively.

Thereafter, the baffle 2 is engaged with the case 3 by the bayonet structure as described above. Specifically, the baffle 2 and case 3 are positioned so that the engagement protrusions 2e correspond to the engagement recessed 3e and are then pressed against each other as indicated by <1> of FIG. 15. The engagement protrusions 2e are then engaged with the portions of the engagement recesses 3e extending along the axis CL 3.

Subsequently, as indicated by <2> of FIG. 15, the baffle 2 is rotated clockwise by the angle θc. The protrusions (not shown) provided on the surfaces of the engagement protrusions 2e of the baffle 2 on the inner side then fit into the grooves 3e1 of the engagement recesses 3e, which gives a click feeling and holds the baffle 2 and case 3 stably.

Next, the tapping screw Nj is inserted into the through hole 2h and is then screwed into the drill hole 3a1 of the boss 3a to integrate the baffle 2 and case 3 with the arch bracket 5 being accommodated inside.

Since the arch bracket 5 is made of resin having flexibility and is semicircular, in the process of elastically narrowing, inserting, and restoring the ends of the arch bracket, the protrusions 5a and 5b can be engaged with the engagement holes 1d and 1e of the hanger 1 very easily.

Moreover, since the protrusions 5a and 5b, which are respectively engaged with the engagement holes 1d and 1e, are connected and integrated by the base 5k. Accordingly, integration of the hanger 1 and case 3 requires only one additional part. Examples of the resin of the arch bracket 5 include POM (polyacetal).

When upper part of the housing HS is inclined toward the head side (inward) with the protrusion 5b being engaged with the engagement hole 1e, the abutment surface 5b3 comes into contact with the abutment surface 1e3 to limit the rotation of the housing HS. When lower part of the housing HS is inclined toward the head side (inward), the abutment surface 5b4 comes into contact with the abutment surface 1e4 to limit the rotation of the housing HS.

As shown in FIG. 10, the angle between the abutment surfaces 1e3 and 1e4 of the engagement hole 1e on the open side is 180 degrees+(α+β) degrees. The housing HS is therefore capable of tilting up by α degrees and down by β degrees.

In such a manner, the abutment surfaces 5b3 and 1e3 and the abutment surfaces 5b4 and 1e4 serve as rotation limiters which limit the angular ranges where the pair of protrusions 5a and 5b rotates, respectively.

As for the inclined surfaces 3f1 and 3f2 of the case 3, which are shown in FIGS. 3 and 6, inclination angles thereof for clearance are determined so that the case 3 does not come into contact with the hanger 1 in the process of tilting the housing HS. This is because if the hanger 1 and case 3 come into contact with each other, the contact sound thereof sometimes feels uncomfortable.

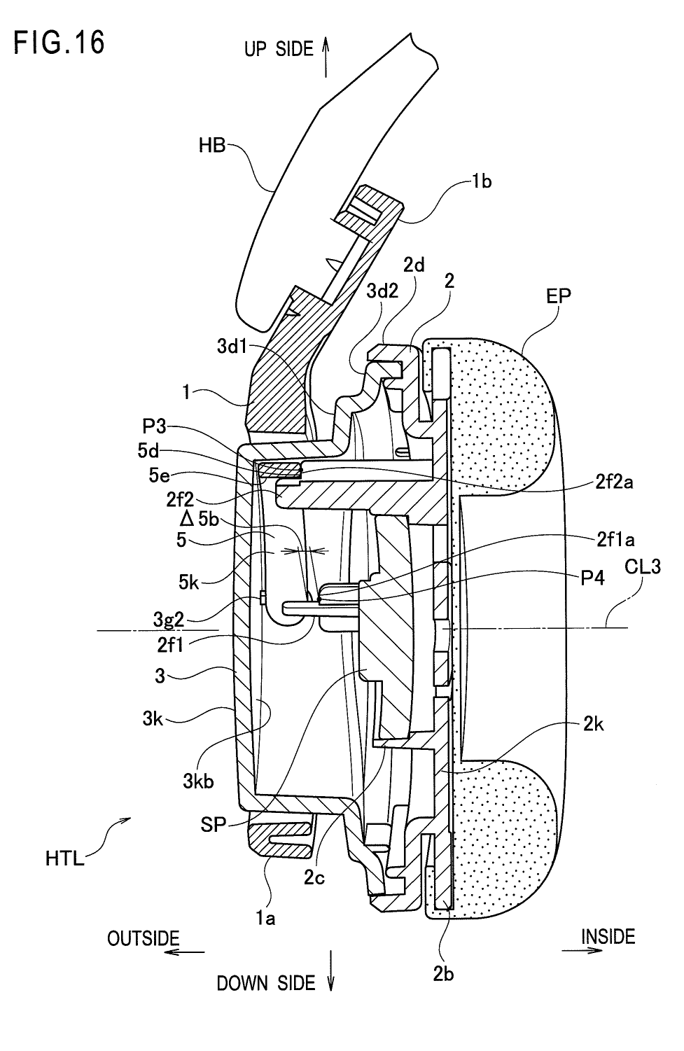

FIG. 16 is a cross-sectional view of the main unit HTL of the headphone 51 taken along a line S1-S1 of FIG. 2.

The arch bracket 5 is accommodated in the base 3k of the case 3. Outward movement of the arch bracket 5 accommodated in the case 3 is limited by the ribs 3g1 to 3g3 (see FIG. 14) .

Inward movement of the arch bracket 5 is limited by the ribs 2f1 to 2f4 of the baffle 2, which is engaged with the case 3 by the bayonet structure.

The ribs 2f2 and 2f3 among the ribs 2f1 to 2f4 are in contact with or close to the arch bracket 5 so as to sandwich the arch bracket 5 in cooperation with the rib 3p3.

The arch bracket 5 is inserted in rectangular regions defined by the step portions 2f2a and 2f3a of the ribs 2f2 and 2f3 as recessed regions.

FIG. 16 shows the arch bracket 5 inserted into the rectangular regions defined by the step portion 2f2a of the rib 2f2 as the recessed regions.

An end surface 5d of the arch bracket 5 on the inner side and a surface 5e thereof on the axis CL3 side face each of the step portions 2f2a and 2f3a. The end surface 5d and the surface 5e are orthogonal to each other.

On the other hand, the ribs 2f1 and 2f4 of the ribs 2f1 to 2f4 are located at the positions corresponding to the protrusions 5a and 5b of the arch bracket 5, respectively.

The ribs 2f1 and 2f4 are provided so that a gap Δ5a (see FIG. 11) and a gap Δ5b (see FIGS. 11 and 16) are interposed between the ribs 2f1 and 2f4 and the arch bracket 5 in a natural state, respectively. This allows the ends of the arch bracket 5 to bend inward by elastic deformation and move inward (in the direction along the axis CL3) by predetermined distances.

When the ends of the arch bracket 5 bend inward and enter the recessed rectangular regions defined by the step portions 2f1a and 2f4a, which are provided in the tops of the ribs 2f1 and 2f4, both the end surface 5d of the arch bracket 5 on the inner side and the surface 5e on the axis CL3 side face each of the step portions 2f1a and 2f4a.

If the ends of the arch bracket 5 deform greatly, the end surface 5d and surface 5e will come into contact with the step portions 2f1a and 2f4a.

As for the arch bracket 5, by the ribs 2f1 to 2f4, inward movement of the end surface 5d is limited, and downward movement of the surface 5e is limited.

In such a manner, inward and downward movements of the arch bracket 5 (in the two directions) are limited, so that the arch bracket 5 can be accurately supported without rattling. The headphone 51 will not make abnormal noise such as rattling noise even when the headphone 51 is shaken. The headphone 51 is therefore provided to a user as a high-quality product.

The limitation of movements of the arch bracket 5 is schematically described in detail with reference to FIG. 11.

As shown in (a) and (b) of FIG. 11, the rib 2f3 is in contact with or close to the arch bracket 5 at a position P2 of an angle θb counterclockwise from the vertical axis CLv. The rib 2f2 is in contact with or close to the arch bracket 5 at a position P3 of an angle θa clockwise from the vertical axis CLv.

Since the gaps Δ5a and Δ5b are interposed between the arch bracket 5 and the ribs 2f4 and 2f1, respectively, the portions of the arch bracket 5 between the positions P2 and P3 and the respective ends thereof can elastically bend as indicated by chain double-dashed lines. In (b) of FIG. 11, the deflections are shown in an exaggerated fashion for easy understanding.

The through holes 3k1 and 3k2 of the case 3, through which the protrusions 5a and 5b of the arch bracket 5 are inserted, have elongated circular shapes longitudinal in the axis CL3 direction so as to allow displacement of the protrusions 5a and 5b due to such elastic deflection.

The protrusions 5a and 5b bend so as to be separated from the axis CL5. The longitudinal direction of the through holes 3k1 and 3k2 is therefore set corresponding to the direction that the protrusions 5a and 5b bend. Moreover, each of the through holes 3k1 and 3k2 is formed so that length ΔD (see (c) of FIG. 6) of parallel sides of the elongated circle is not less than the gap Δ5a or Δ5b.

By using elastic deformation of the both arms and forming the through holes 3k1 and 3k2 in the case 3 in such shapes (for example, elongated circles) that allow deformation of the arch bracket 5, the main unit HTL can be configured to swivel.

The weight (the degree of resistive force) on swivel can be controlled by changing the positions P3 and P2 of the ribs 2f2 and 2f3, which come in contact with or close to the arch bracket 5, to the right or left in (a) of FIG. 11 (see circular arrows DR10a and DR10b in (a) of FIG. 11).

The longer the distances between the positions P2 and P3 and the respective ends in the arch bracket 5 (hereinafter, also referred to as lengths of deformed arm portions), the lighter the swivel. In other words, the spring constants of the deformed arm portions can be easily optimized.

The weight on swivel can be changed also by changing the cross-sectional shape of the arch bracket 5. The cross-sectional shape of the base 5k may be designed so that the flexural rigidity in the direction of bending is optimized at the process of swivel. Specifically, the wall thickness and width of the arch bracket 5 are properly selected, or whether to provide slits and notches for the arch bracket 5 is determined.

Moreover, the resistive force in the process of inclining the front side of the housing HS inward (toward the head side) by swivel can be easily made different from the resistive force in the process of inclining the back side of the housing HS inward by swivel.

If the arch bracket 5 is produced with varied spring constants at the deformed arm portions, the case 3 and hanger are prepared as common parts, thus preventing the manufacturing cost of the headphone 51 from increasing.

In the main units HTL and HTR, the arch bracket 5 is fixed as follows without the need for additional exclusive parts. The arch bracket 5 is sandwiched by the rib 3g3 provided for the case 3 and the ribs 2f2 and 2f3 provided for the baffle 2, and the positions of the ribs 2f2 and 2f3 are naturally determined to the predetermined positions by bayonet engagement of the case 3. That is to say, the arch bracket 5 is sandwiched by the case 3 and baffle 2 to be supported.

A concrete description is given with reference to (a) of FIG. 11. The ribs 2f1 to 2f4 are located at the positions P1a to P4a when the engagement protrusions 2e are located corresponding to the engagement recesses 3e in the process of fitting the baffle 2 to the case 3 by bayonet engagement.

The positions P1a to P4a are at the angle θc counterclockwise from the positions P1 to P4, respectively. By relative clockwise rotation of the angle θc in the process of bayonet engagement, the ribs 2f1 to 2f4 move from the positions P1a to P4a to the predetermined positions P1 to P4, respectively.

Such a structure can prevent an increase in cost without requiring additional parts. Moreover, the position of the arch bracket 5 sandwiched by the ribs is stable and can be accurately determined. Accordingly, very few defective products are produces, and the quality of good products can be kept extremely high.

Moreover, the arch bracket 5 is pressed and held at plural separate places in the base 5k by the plural ribs 2f2 and 2f3, which are spaced from each other.

Accordingly, the base 5k will not be inclined or displaced and can be firmly held in the housing HS. According to this structure, the headphone 51 in use will not make unnecessary abnormal noise.

In the arch bracket 5, the both ends of the base 5k are free so that the pair of protrusions 5a and 5b bend by predetermined amounts in the direction away from the axis CL5, which passes through the ends of the base 5k in a natural state, for example, in the direction orthogonal to the extended surface of the base 5k.

Moreover, the pair of through-holes 3k1 and 3k2 is formed in such shapes that allow predetermined amounts of deflection of the pair of protrusions 5a and 5b, respectively. In the description of the embodiment, the through-holes 3k1 and 3k2 are elongated holes but not limited to elongated holes.

In a conventional hanger having a ring-shaped connecting portion, even if a pair of support pins, which are formed in the connecting portion and protruded so as to come close to each other in the radial direction, are tried to be attached to insertion holes of the housing provided corresponding thereto, it is difficult to attach the support pins to the insertion holes by elastically deforming and widening the conventional hanger like a U-shaped hanger because the conventional hanger has a closed ring-shape.

Moreover, it is examined that a boss is integrally formed in the housing and is engaged with a recess provided for the hanger. However, the hanger cannot be deformed and widened much, and the amount of engagement between the boss and the recess needs to be small. When such a headphone falls, the hanger can be easily detached.

In order to increase the amount of engagement so that the boss cannot be easily detached due to fall of the headphone or the like, it is examined that the boss is bonded and fixed to the housing by a later process. However, this requires an additional process of applying an adhesive. Furthermore, since the hanger cannot be elastically deformed and widened very much, it is difficult to diassemble the headphone and to repair the same. Accordingly, such a hanger is not preferable and is desired to be improved.

On the other hand, the headphone 51 of the above-described embodiment can be easily diassembled and can be repaired although the hanger includes the ring-shaped connecting portion.

Moreover, in one of conventional attachment methods, a pair of separate members equivalent to the support pins are inserted into the insertion holes from the inside of the housing and are fixed to the connecting portion instead of the support pins formed in the connecting portion of the hanger including a ring-shape connecting portion.

Such a case requires at least two additional parts, thus increasing in cost. Accordingly, there is a demand for an improvement in cost reduction.

On the other hand, according to the headphone 51 of the aforementioned embodiment, even though the hanger includes a ring-shaped connecting portion, it is possible to prevent an increase in cost and achieve low cost.

The embodiment of the present invention is not limited to the aforementioned configuration and includes a modification without departing from the scope of the present invention.

The shape of the connecting portion la of the hanger 1 is not limited to a circle and may be another closed shape such as an ellipse, an elongated circle, a polygon, or a combination thereof.

The case 3 is provided with the three ribs 3g1 to 3g3, but the number of such ribs is not limited to three and may be four or more. Moreover, the baffle 2 is provided with the four ribs 2f1 to 2f4, but the number of such ribs is not limited to four and may be five or more.

As described above, even though the hanger includes the ring-shaped connecting portion, the main units of the headphone 51 of the embodiment can swivel, and the headphone 51 can provide a good fit.

According to the headphone 51 of the embodiment, even though the hanger includes the ring-shaped connecting portion, it is possible to prevent an increase in the number of parts and therefore achieve lower cost.

According to the headphone 51 of the embodiment, although the hanger includes the ring-shaped connecting portion, the headphone 51 can be easily assembled and diassembled.

What is claimed is:

1. A headphone comprising:
a housing;
a hanger which includes: a connecting portion formed in a ring-shape; and a pair of engagement portions opposite to each other in a radial direction of the connecting portion and supports the housing unit to allow the housing unit to rotate; and
a bracket which is accommodated in the housing and includes: a flexible curved base; and a pair of protrusions protruding at both ends of the base portion in directions away from each other on an axis penetrating the both ends, wherein
the housing includes a pair of through holes at positions corresponding to the pair of engagement portions, and
the pair of protrusions is rotatably engaged with the pair of engagement portions through the pair of through holes.

2. The headphone according to claim 1, wherein
in the bracket, the both ends of the base are free ends to allow the pair of protrusions to bend by predetermined amounts in a direction away from the axis, and
the pair of through holes is formed in shapes which allow the pair of protrusions to bend by the predetermined amounts.

3. The headphone according to claim 2, wherein the pair of through holes is elongated holes longitudinal in a direction that the pair of protrusions bends.

4. The headphone according to claim 1, wherein the bracket has a plurality of portions held by ribs provided for the housing.

5. The headphone according to claim 1, further comprising a rotation limiter which controls an angle of rotation of each of the pair of protrusions within a predetermined range.

6. The headphone according to claim 1, wherein the housing accommodates a speaker inside.

7. The headphone according to claim 1, wherein the housing includes a first casing and a second casing which are combined, the first and second casings being located inside and outside when the headphone is in use, respectively, and
the bracket is accommodated in one of the first and second casing, and
the one casing includes a pair of through holes, and
the bracket is sandwiched and supported by the one casing and the other one of the first and second casings.

8. The headphone according to claim 7, wherein
the first and second casings include engagement structures which are engaged with each other by relative rotation thereof, and
the other casing includes a rib which allows the bracket to move to the predetermined position by the rotation.
